(19) United States
(12) Patent Application Publication
(10) Pub. No.: US 2006/0009982 A1
(43) Pub. Date: Jan. 12, 2006

(54) Method and apparatus for censoring a word

(76) Inventor: Michael Edward Janzen, Vancouver (CA)

Correspondence Address: Fasken Martineau DuMouliln LLP, 2100 - 1075 West Georgia Street, Vancouver, BC, V6E 3G2, CA

(21) Appl. No.: 11/156,797

(22) Filed: Jun. 21, 2005

Related U.S. Application Data
(60) Provisional application No. 60/580,703, filed on Jun. 21, 2004.

(51) Int. Cl. G10L 11/00

(52) U.S. Cl. 704/272

(57) ABSTRACT

A hand-held electronic device for censoring, validating, or invalidating comments made by oneself or others, usually to comic effect, for various benefits, including, but not limited to, self-amusement, relieving tension or boredom, discouraging verbal bullying or verbal abuse, or gaining social status. The user of the device can activate various sound effects, which may include, but are not limited to: the ‘Bleep’ sound used to censor coarse language on TV; the ‘Buzz’ sound used to indicate “wrong answer” on TV game shows, and the ‘Ding’ sound used to indicate “correct answer” on TV game shows.

This application claims the benefit of U.S. Provisional Patent Application No. 60/580,703, filed Jun. 21, 2004, which is hereby incorporated by reference.

### FIELD OF THE INVENTION

The invention relates to noise makers and more particularly to noise makers which produce specific culturally-relevant sound effects which allow the user to manipulate spoken language in a manner which censors, validates, or invalidates the statements made by oneself or others, in a manner which allows the user to gain power over others, or to amuse the user or others.

### BACKGROUND OF THE INVENTION

Electronic noisemakers of various types are available, such as electronic musical instruments, including miniature keyboards. Electronic memory games such as “Simon” produce a number of single-frequency tones. Touch-tone phones or toy phones may ‘beep’ at various frequencies, or produce melodies, when buttons are pressed.

An example of a noisemaker in the art is the device known as a FART MACHINE, which is a remote-controlled electronic device which emits various ‘fart’ noises for comic effect. Other similar devices are timer-activated, rather than remote-controlled. Electronic toy guns which produce ‘firing’ sounds (and may produce ‘laser’ effects) are also found in the art, including those described in U.S. Pat. Nos. 4,175,353; 4,365,439; 4,586,715; and 6,814,667.

The present device provides both the ‘power’ benefit of a toy used as a weapon “against” others, and the “humour” benefit of a toy such as a fart sound effect emitter.

### SUMMARY OF THE INVENTION

A method of censoring a word is provided, comprising the steps of: (a) providing a handheld portable device comprising: a casing; a first actuator; a speaker; and a power source; and (b) on activation of said first actuator, said speaker emitting a ‘bleep’ sound effect to censor the word. The portable device may include a second actuator, wherein on activation of said second actuator, said speaker emits a ‘ding’ sound emitted to indicate approval. The portable device may also include a third actuator, wherein on activation of said third actuator, said speaker emits a ‘buzz’ sound to indicate disapproval. The ‘bleep’ sound may be emitted until said actuator is deactivated. The device further may also include a LED that turns on when said first actuator is activated.

A device is provided comprising: a casing; a first actuator, a second actuator, and a third actuator; a speaker; and a power source; wherein activation of said first actuator causes said speaker to produce a ‘bleep’ sound; activation of said second actuator causes said speaker to produce a ‘ding’ sound; and activation of said third actuator causes said sound emitter to produce a ‘buzz’ sound and wherein said device is concealable within a user's pocket.

The power source may be a replaceable battery. The device may further include a fourth actuator, wherein activation of said fourth actuator powers said device.

The first, second and third actuators may be back lit by respective first, second and third LEDs, said first, second and third LEDs lighting in a ‘pulse’ pattern when one of said first, second or third actuators are activated. The device of claim 11 may include a fourth LED, wherein said fourth LED is on when said fourth actuator is activated.

The casing is preferably made of a light, hard plastic and comprises a first half and a second half, said first half secured to said second half via a plurality of screws, or via snaps or other fastening devices. The device may include a volume control for controlling the volume of sound emitted.

The device may also include a microprocessor and a first switch, a second switch and a third switch corresponding to said first actuator, said second actuator and said third actuator.

### BRIEF DESCRIPTION OF THE DRAWINGS

FIG. 1 is a top view of a device according to the invention; and

FIG. 2 is a top cut away view thereof.

### DETAILED DESCRIPTION OF THE INVENTION

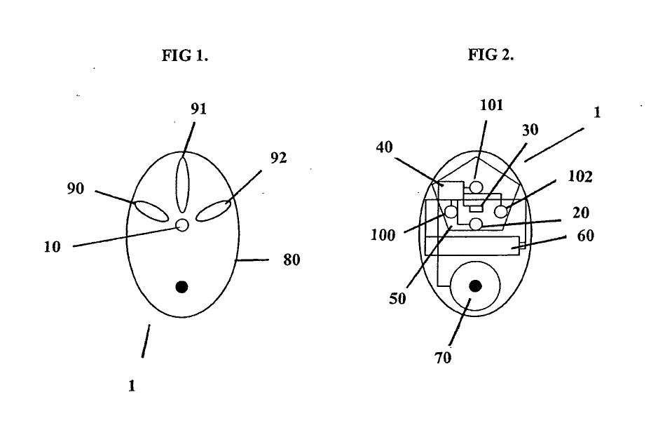

As seen in FIGS. 1 and 2, the invention is a hand-held electronic device 1, which preferably has a mass of approximately 50 g. Other masses may be appropriate, but device 1 should be light enough to be easily held in a user's hand. Device 1, includes external casing 80 having dimensions that are preferably approximately 6 cm long×4 cm across×2 cm deep. External casing 80 may be fabricated from one of various types of plastic, metal, or other material, but a light hard plastic casing is preferable. Preferably device 1 is small enough to easily be concealed within a palm or pocket.

Device 1 includes electronics such as a printed circuit board (PCB) 50 with microprocessor 40 (or equivalent circuits); actuators 10, 90, 91, 92; switches 20, 100, 101, 102; battery 60; speaker 70; and light 30.

Preferably actuators 10, 90, 91 and 92 are of the push button type, and form a translucent multi-button elastomer. Actuators may also be, but are not limited to, button switches, keys, touchpads, or sensors, and may include an integrated light pipe. Actuator(s) 10, 90, 91, and 92 contact and activate respectively, switches 20, 100, 101, 102 (which are preferably push switches) on PCB 50, which activates microprocessor 40 to generate signals to operate the light and sound effects.

Actuators 10, 90, 91, 92 may be positioned as shown in FIG. 1, so they can be easily accessed by a user. Each actuator 10, 90, 91, 92 when activated, activates a corresponding switch 20, 100, 101, 102. Each switch 20, 100, 101, 102 activates a microprocessor 40 or equivalent circuit as described below.

Primary actuator 10, when activated, activates switch 20 which activates microprocessor 40, which turns device 1 on. The primary actuator 10, when activated while device 1 is on, activates a switch 20, which activates the microprocessor 40, which turns device 1 off. Device 1 may switch off automatically after a period of disuse, to conserve power. Alternatively, device 1 may be always on, to simplify usage. In yet another embodiment, device 1 will not have primary actuator 10, and will automatically turn on whenever actuators 90, 91 or 92 are activated.

When device 1 is on, microprocessor 40 may send a signal to light 30, which is preferably an LED. Light 30 may also back-illuminate actuators 10, 90, 91, 92, at regular time intervals, for a ‘pulsing’ effect. Such pulsing may illuminate the buttons or, in a different embodiment a selection of LEDs (not shown) on casing 80. In such an embodiment the pulsing may take place at a rate of 1 Hz.

Each of the (one or more) secondary actuators 90, 91, 92, when activated, activates a corresponding switch 100, 101, 102, which activates the microprocessor 40, which activates the speaker 70, which produces a sound effect corresponding to the secondary actuator 90, 91, 92 activated by the user. Speaker 70 is preferably a round alarm speaker. In a preferred embodiment, actuator 90 causes speaker 70 to emit a ‘Bleep’ sound; actuator 91 causes speaker 70 to emit a ‘Ding’ sound and actuator 92 causes speaker 70 to emit a ‘Buzz’ sound.

Microprocessor 40, switches 20, sound emitter 70, and light emitter 30 may be fastened or connected to a printed circuit board 50. A battery 60 (preferably a 12 volt battery) or other suitable power source powers all components.

External casing 80 of device 1 may be plastic, metal, or any other suitable material. Casing 80 is probably composed of two halves, secured together by screws (not shown), or via snaps or other fastening devices.

In use device 1 produces specific sound effects, whose cultural semantics allow the user to censor, validate, or invalidate comments made by others or oneself during social interactions, for the purpose of gaining social status or power, or simply for comic effect, relieving tension or boredom. These sound effects may include any or all of the following three common sound effects from television: the ‘Bleep’ sound commonly used on television and the like to censor and substitute for coarse language; the ‘Ding’ sound used to indicate “correct answer” on TV game shows; and the ‘Buzz’ sound used to indicate “wrong answer” on TV game shows. Preferably device 1 has different actuators 90, 91, 92 for each type of sound. The ‘Bleep’ sound is likely emitted as long as actuator 90 is activated, while the ‘Ding’ and ‘Buzz’ sounds are likely to be emitted only briefly, following activation (similar to the duration of these sounds as heard on TV game shows) of actuators 91 and 92 respectively.

The ‘Buzz’ sound can be approximated by a saw tooth wave with a frequency of 80 Hz although other frequencies are possible. The sounds emitted are preferably in the 80 to 85 dB range. The ‘Bleep’ sound may be produced by a 1000 Hz sine wave (although other frequencies may be used). Preferably the sounds are loud enough to overpower nearby conversation, so that, for example, the ‘Bleep’ sound will render the “censored” word spoken inaudible or unintelligible (this will of course, depend on the volume of the sound emitted and the volume of the speaker). The durations for the emitted sounds (when the buttons are pressed once) would preferably be about:
for the ‘Bleep’ sound: 0.3 seconds;
for the ‘Buzz’ sound: 0.5 seconds; and
for the ‘Ding’ sound: 0.7 seconds.

Preferably, if the button remains pressed down, speaker 70 will continue to emit the sound as long as actuator 90 is activated, either as a constant or repeated sound. In an alternative embodiment, the ‘Bleep’ sound will continue as long as actuator 90 is activated, while the ‘Buzz’ and ‘Ding’ sounds will repeat if their respective actuators 91, 92 are activated, rather than the length of time the sound lasts extended.

There are several other embodiments of the invention which may be used. For example, in one embodiment (not shown) there may be a single actuator for emitting sound, and a switch to select which of the available sounds to be emitted. In another embodiment, there may be a volume control to control the volume of the emitted sound.

Other features may include an LED display to indicate activation (for example the actuator could be lit when it is activated). For example, actuators 90, 91 and 92 may each be back lit by respective LEDs, or by a larger number of LEDs, lighting in a ‘pulse’ pattern when the device is in active mode. Alternatively, there may be only a single LED illuminating any number of the acuators, or another part of the device.

The user of device 1 may use it to activate sound effects to censor, validate, or invalidate comments made by a target individual, where the target individual may be oneself, a family member, friend, enemy, or stranger. The user gains power and status over the target, as the device 1 provides an “objective, authoritative commentary” on comments made. Particularly when the sound effects are unexpected, the comic effect can be great (as evidenced by television shows such as “South Park”). The device 1 can be hidden and activated in a pocket, to enhance the surprise, mystery, and comic effect of the sound effects.

The user may activate the ‘Bleep’ sound effect for various reasons, including, but not limited to: shielding oneself or bystanders (e.g., children) from profanity, teasing, name-calling, verbal abuse, or other offensive language; discouraging the target's use of such language; and using the humour of the sound effect to diffuse the tension created by such language.

The user may activate the ‘Ding’ sound effect to validate comments (e.g., “I'm brilliant!”, or “Are you nuts?”) made by the target (usually oneself or a confederate), with which the user agrees, usually to comic effect.

The user may activate the ‘Buzz’ sound effect to invalidate comments (e.g., “You're an idiot!”) made by the target (usually a bully), with which the user does not agree. Early in his career, Robin Williams imitated this sound effect (followed by “Wrong answer!”), to great comic effect. This sound effect is particularly useful when the user has not yet mastered the timing to ‘bleep’ his target (e.g., “You're a son of a—“*BLEEP!*), and must settle for ‘buzzing’ his target after the insult has been said (e.g., “You're a son of a b****!” . . . *BUZZ!*, followed by . . . ”No, YOU are!” . . . *DING!*). This combination of *BUZZ* and *DING* can be quite powerful in taking away the power of a bully or braggart.

All the sound effects may also be activated among friends, simply for amusement.

The pulsing light effect displayed by LED 30 will help to visually convey the ‘power’ benefit to consumers. The power source, battery 60 should be sufficient to last for thousands of activations and may be replaced by user should it wear out.

Although the particular preferred embodiments of the invention have been disclosed in detail for illustrative purposes, it will be recognized that variations or modifications of the disclosed apparatus lie within the scope of the present invention.

I claim:

1. A method of censoring a word, comprising the steps of:
(a) providing a handheld portable device comprising:
a casing;
a first actuator;
a speaker; and
a power source; and
(b) on activation of said first actuator, said speaker emitting a ‘bleep’ sound effect to censor the word.

2. The method of claim 1, wherein said portable device further comprises a second actuator, wherein on activation of said second actuator, said speaker emits a ‘ding’ sound.

3. The method of claim 2, wherein said ‘ding’ sound is emitted to indicate approval.

4. The method of claim 3, wherein said portable device further comprises a third actuator, wherein on activation of said third actuator, said speaker emits a ‘buzz’ sound.

5. The method of claim 4, wherein said ‘buzz’ sound is emitted to indicate disapproval.

6. The method of claim 5 wherein said ‘bleep’ sound is emitted until said actuator is deactivated.

7. The method of claim 6, wherein said device further comprises a LED, said LED turning on when said first actuator is activated.

8. A device comprising:
a casing;
a first actuator, a second actuator, and a third actuator;
a speaker; and
a power source;
wherein activation of said first actuator causes said speaker to produce a ‘bleep’ sound; activation of said second actuator causes said speaker to produce a ‘ding’ sound; and activation of said third actuator causes said sound emitter to produce a ‘buzz’ sound and wherein said device is concealable within a user's pocket.

9. The device of claim 8 wherein said power source is a battery.

10. The device of claim 9 further comprising a fourth actuator, wherein activation of said fourth actuator powers said device.

11. The device of claim 10 wherein said first, second and third actuators are back lit by respective first, second and third LEDs, said first, second and third LEDs lighting in a ‘pulse’ pattern when one of said first, second or third actuators are activated.

12. The device of claim 11 further comprising a fourth LED, wherein said fourth LED is on when said fourth actuator is activated.

13. The device of claim 12 wherein said casing is made of a light, hard plastic.

14. The device of claim 13 further comprising a volume control for controlling the volume of sound emitted.

15. The device of claim 14 wherein said battery is replaceable.

16. The device of claim 15 further comprising a microprocessor and a first switch, a second switch and a third switch corresponding to said first actuator, said second actuator and said third actuator.

17. The device of claim 16 wherein said casing comprises a first half and a second half, said first half secured to said second half via a plurality of screws.
